(19) United States
(12) Patent Application Publication
(10) Pub. No.: US 2014/0025448 A1
(43) Pub. Date: Jan. 23, 2014

(54) METHOD AND APPARATUS FOR PROVIDING A MARKETING ENGINE

(71) Applicant: Social2Step, LLC, Detroit, MI (US)

(72) Inventors: James R. Maxfield, IV, Houston, TX (US); Susan E. Burke, Ada, MI (US)

(73) Assignee: Social2Step, LLC, Detroit, MI (US)

(21) Appl. No.: 13/947,194

(22) Filed: Jul. 22, 2013

Related U.S. Application Data
(60) Provisional application No. 61/674,069, filed on Jul. 20, 2012.

(51) Int. Cl. G06Q 50/00; G06Q 30/02

(52) U.S. Cl. CPC G06Q 50/01; G06Q 30/0214
USPC 705/14.16

(57) ABSTRACT

Embodiments of the present disclosure may empower companies to financially leverage the connected communities of their employees to drive company revenues, brand awareness and product adoption. A marketing engine may act as an engagement catalyst for these employees. Employees have personal spheres of influence in their socially connected communities that can be utilized by their employer's marketing initiatives. One-to-one marketing efforts by the employees are extremely powerful and impactful when compared to broader advertising messages. The marketing engine may engage employees in the promotion of products and services offered by their company through social media campaigns. In return, the company may reward those employees for their involvement within their connected communities through a series of rewards. The employees may participate in these micro-marketing activities without the company knowing which employees are participating and the extent of that participation.

### CROSS-REFERENCE TO RELATED APPLICATIONS

This application claims the benefit of U.S. provisional Application No. 61/674,069 filed Jul. 20, 2012, the disclosure of which is incorporated in its entirety by reference herein.

### TECHNICAL FIELD

The present disclosure relates to a method, a non-transitory computer readable medium and an apparatus for providing a marketing engine for use in marketing company promotion through an employee media channel.

### BACKGROUND

Companies can spending significant funds on advertising through traditional major media channels (e.g., television, radio, billboard, print, direct mailing, and the like). However, company employees can be powerful brand advertisers as well. Indeed, Word of Mouth (WOM) has always been a high-value marketing channel for brands. On average, WOM recommendations result in 3-5× higher conversion rates than traditional channels. Research has also shown that consumers trust friends and peers more than they trust brand advertising. For instance, research indicates that 90% of consumers trust recommendations from their friends and 17% of consumers trust opinions posted online. Further, studies show that the average person in certain geographic regions or countries has more than 600 social connections. Thus, by leveraging the contacts of a company's own employees, advertising messages or promotions can reach a large audience rapidly and with the potential for relatively large conversion rates.

### SUMMARY

One or more embodiments of the present disclosure are directed to a method for marketing company promotions through an employee media channel using a marketing engine. For example, the method may include receiving, from a company, input indicative of a promotion and a reward value associated with sharing the promotion. The method may further include notifying a plurality of employees of the company about the promotion and the reward value and receiving authorization from at least one employee to share the promotion with at least one social contact in at least one digital social network of the employee in a manner that does not allow the company to know what the employee has done specifically. Upon receiving authorization, the method may include sending the promotion to the social contact through the digital social network on behalf of the employee using an application programming interface. Further, the method may include crediting the reward value to an account for each employee that shared the promotion and preventing the company from receiving information indicating individual employee participation in the sharing of promotions.

The method may further include generating a report that provides the company with promotion sharing totals in the aggregate only for the plurality of employees. In one or more embodiments, the method may include receiving a share limit for the promotion for each employee and notifying the plurality of employees about the promotion and the reward value based on the share limit. Moreover, notifying the plurality of employees may comprise receiving login credentials for an employee and generating an electronic form including at least the promotion for display on a client device accessed by the employee.

Alternatively, notifying the plurality of employees may include sending an electronic communication about the promotion to an employee, the electronic communication including soliciting employee authorization to share the promotion. The electronic communication may be an electronic mail message. Further, the electronic communication may suggest a subset of social contacts in the employee's digital social network to share the promotion with. The method may further include receiving input indicative of a frequency for sending electronic communications about the promotion to the employee.

In one or more embodiments, each employee account may have a total account value based at least in part on reward values accumulated by the employee for sharing promotions. Further, the method may comprise providing an electronic form including a number of available reward items and a reward cost for each reward item and receiving a redemption request, from the employee, to redeem a reward item for the reward cost. In response, the method may further include processing the redemption request to facilitate delivery of the reward item to the employee and deducting the reward cost from the total account value of the employee's account. The company may not be provided with information identifying individual employee redemption activity.

In one or more embodiments, receiving authorization from at least one employee may include receiving input indicative of a selection of the promotion by the employee and a selection of a digital social network by the employee. The method may further include receiving input indicative of a selection of the at least one social contact in the selected digital social network by the employee. The method may also include receiving input from the company limiting the number of social contacts that the employee can select to share the promotion.

One or more additional embodiments are directed toward a computer system for providing a marketing engine for propagating company promotions through an employee media channel. The computer system may include a memory device for storing computer-readable instructions and a processor for executing the computer-readable instructions stored in the memory device. The computer-readable instructions, when executed by the processor, may implement the following functions: receiving, from a company, input indicative of a promotion and a reward value associated with sharing the promotion; notifying a plurality of employees of the company about the promotion and the reward value; receiving authorization from at least one employee to share the promotion with at least one social contact in at least one digital social network of the employee; sending the promotion to the social contact through the digital social network on behalf of the employee; and crediting the reward value to an account for each employee that shared the promotion without providing the company with information indicating individual employee participation in the sharing of promotions through the employee media channel.

The system may further include a promotion database for storing data associated with a number of company promotions including the promotion and the reward value and an employee database including an entry associated with each employee and corresponding to each employee account. Each entry may include employee identification information, employee activity information and a total account value.

The system may further include a company module and an employee module. The company module may have a marketing component and an administrative component. The marketing component may provide an interface for receiving promotion information input by the company and storing the promotion information in the promotion database. The administrative component may provide an interface for receiving the employee identification information input by the company and storing the employee identification information in the employee database; and

The employee module may have a promotion sharing component and a reward redemption component. The promotion sharing component may provide an interface for receiving authorization from employees to share promotions with their social contacts through their digital social networks and crediting employee accounts corresponding reward values for sharing promotions. The reward redemption component may provide an interface for employees to redeem rewards for sharing promotions and deducting the reward cost from the total account value. The company may not have access to the employee activity information and the total account value for each employee.

The total account value for each employee account may be based at least in part on reward values accumulated by the employee for sharing promotions. To this end, the computer-readable instructions may further implement the following functions: providing an electronic form including a number of available reward items and a reward cost for each reward item; receiving a redemption request, from the employee, to redeem a reward item for the reward cost; processing the redemption request to facilitate delivery to the employee; and deducting the reward cost from the total account value of the employee's account without providing the company with information indicating individual employee redemption activity.

Further, notifying the plurality of employees may include receiving login credentials for an employee and generating an electronic form including at least the promotion for display on a client device accessed by the employee. Alternatively, notifying the plurality of employees may include sending an electronic communication about the promotion to an employee, the electronic communication including a request for employee authorization to share the promotion.

Additionally, one or more embodiments of the present disclosure may be directed toward a non-transitory computer-readable storage medium containing machine instructions that, when executed by a processor, implement the following steps: receiving, from a company, input indicative of a promotion and a reward value associated with sharing the promotion; notifying a plurality of employees of the company about the promotion and the reward value; receiving authorization from at least one employee to share the promotion with at least one social contact in at least one digital social network of the employee; sending the promotion to the social contact through the digital social network on behalf of the employee using an application programming interface; and crediting the reward value to an account for each employee that shared the promotion without providing the company with information indicating individual employee participation in the sharing of promotions.

### BRIEF DESCRIPTION OF THE DRAWINGS

FIG. 1 is a simplified, exemplary block diagram of a computer system suitable for use in performing the methods, steps, operations and/or functions described herein;

FIG. 2 is a simplified, exemplary network diagram of a system for using employees to market company promotions, in accordance with one or more embodiments of the present disclosure;

FIG. 3 depicts an exemplary employee database entry, in accordance with one or more embodiments of the present disclosure;

FIG. 4 depicts an exemplary promotion database entry, in accordance with one or more embodiments of the present disclosure;

FIG. 5 depicts an exemplary reward database entry, in accordance with one or more embodiments of the present disclosure;

FIG. 6 is a simplified, exemplary block diagram of a marketing engine module, in accordance with one or more embodiments of the present disclosure; and

FIG. 7 is a simplified, exemplary process flowchart of a method for marketing company promotions through an employee media channel, in accordance with one or more embodiments of the present disclosure.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, may be arranged, substituted, combined, and designed in a wide variety of different configurations, all of which are explicitly contemplated and make part of this disclosure.

As used in this disclosure, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, an algorithm and/or a computer. By way of illustration, both an application running on a server and the server can be a component. A component can be localized on one computer and/or distributed between two or more computers. Likewise, as used in this disclosure, the term “database” is intended to refer to one or more computer-related entities for the storage and access of data; and does not necessarily pertain to any manner or structure in which such data is stored. Further, the recitation of a first database and a second database does not necessarily require that such databases are separate from one another, either with respect to the data storage location(s), device(s) and/or structure(s).

As used herein, the term “widget” generally refers to a software-based component of any graphical user interface (whether it be on a computer, a web-site, a mobile device, a hand-held device and the like) in which the user interacts. For example, a widget may be a graphical user interface element that may display an information arrangement capable of being changed by a consumer, such as a window, text box, hyperlink or button. A widget may provide a single interaction point for manipulating a given kind of data. Widgets are basic visual building blocks which, combined in an application, hold all the data processed by the application and the available interactions on this data. In addition to application widgets, a widget may include a web widget (which may include any code that may be embedded within a page of HTML, e.g., a web page).

Implementations of illustrative embodiments disclosed herein may be captured in programmed code stored on machine readable storage mediums, such as, but not limited to, computer disks, CDs, DVDs, hard disk drives, programmable memories, flash memories and other permanent or temporary memory sources. Execution of the programmed code may cause an executing processor to perform one or more of the methods described herein in an exemplary manner.

A brief, general description of a suitable computing environment in which the various aspects of the present disclosure may be implemented follows. While one or more embodiments of the present disclosure relate to the general context of computer-executable instructions that may run on one or more computers, those skilled in the art will recognize that the subject matter may also be implemented in combination with other program modules and/or as a combination of hardware and software.

Generally, program modules include routines, programs, components, data structures, etc., that may perform particular tasks or implement particular abstract data types. Aspects of the inventive methods may be practiced with other computer system configurations, including single-processor or multiprocessor computer systems, minicomputers, mainframe computers, as well as personal computers, hand-held wireless computing devices, microprocessor-based or programmable consumer electronics, and the like, each of which can be operatively coupled to one or more associated devices. Aspects of the inventive embodiments may also be practiced in distributed computing environments where certain tasks may be performed by remote processing devices that are linked through a communications network. In a distributed computing environment, program modules may be located in both local and remote memory storage devices.

A computer may include a variety of computer readable media. Computer readable media may be any available media that can be accessed by the computer and includes both volatile and nonvolatile media, removable and non-removable media. By way of example, and not limitation, computer readable media may comprise computer storage media and communication media. Computer storage media may include volatile and nonvolatile, removable and non-removable media implemented in any method or technology for storage of information such as computer readable instructions, data structures, program modules or other data. To this end, computer storage media may include RAM, ROM, EEPROM, flash memory or other memory technology, CD ROM, digital video disk (DVD) or other optical disk storage, magnetic cassettes, magnetic tape, magnetic disk storage or other magnetic storage devices, or any other medium which may be used to store the desired information and which may be accessed by the computer.

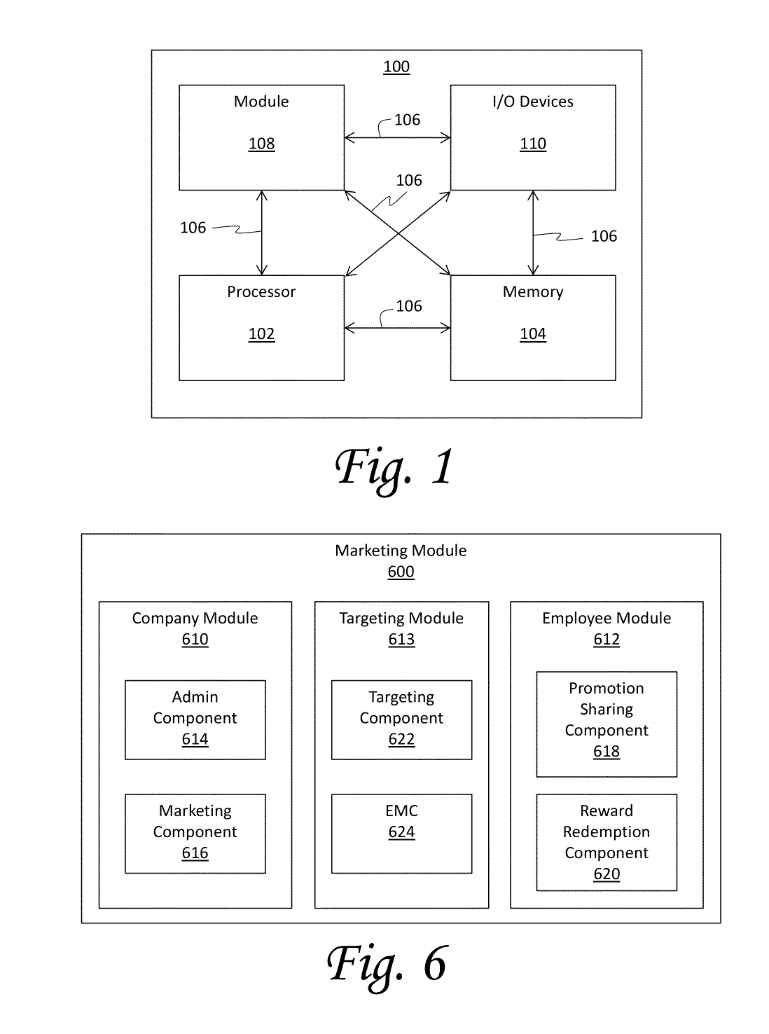

An exemplary environment for implementing various aspects of the present disclosure may include a computer system 100 as illustrated in FIG. 1. For instance, FIG. 1 depicts a high level block diagram of a general purpose computer suitable for use in performing the various methods, steps, operations and/or functions described herein. As depicted in FIG. 1, the computer may have a processing unit 102, a system memory 104, and a system bus 106. The system bus 106 may couple system components including the system memory 104 to the processing unit 102. The processing unit 102 may be any of various commercially available processors. Dual microprocessors and other multi-processor architectures may also be employed as the processing unit.

The system bus 106 may be any of several types of bus structure that may further interconnect to a memory bus (with or without a memory controller), a peripheral bus, and a local bus using any of a variety of commercially available bus architectures. The system memory 104 may include read only memory (ROM) and/or random access memory (RAM).

A number of program modules 108 may be stored in computer drives and RAM, including an operating system, one or more application programs, other program modules and program data. All or portions of the operating system, applications, modules, and/or data may also be cached in the RAM. Aspects of the present disclosure may be implemented with various commercially available operating systems or combinations of operating systems.

The computer may further include various input/output devices 110. For instance, a user may enter commands and information into the computer through one or more wired/wireless input devices (e.g., a touch screen display, a keyboard and/or a pointing device, such as a mouse). These and other input devices may be connected to the processing unit 102 through an input device interface (not shown) that is coupled to the system bus 106, but may be connected by other interfaces, such as a parallel port, an IEEE 1394 serial port, a USB port, an IR interface, etc.

Output devices, such as a display monitor or other type of display device, may also be connected to the system bus 106 via an interface, such as a video adapter. In addition to the monitor, a computer may include other peripheral output devices, such as speakers, printers, storage devices, modems, and the like.

The computer system 100 may operate in a networked environment using logical connections via wired and/or wireless communications to one or more remote computers. The remote computer(s) may be a workstation, a server computer, a router, a personal computer, a portable computer, a personal digital assistant, a cellular device, a microprocessor-based entertainment appliance, a peer device or other common network node, and may include many or all of the elements described relative to the computer. The logical connections depicted include wired/wireless connectivity to a local area network (LAN) and/or larger networks, for example, a wide area network (WAN). Such networking environments may facilitate enterprise-wide computer networks, such as intranets, all of which may connect to a global communications network such as the Internet.

The computer system 100 may be operable to communicate with any wireless devices or entities operatively disposed in wireless communication, e.g., a desktop and/or portable computer, cellular device, portable data assistant, communications satellite, and telephone. This may include at least Wi-Fi (such as IEEE 802.11x (a, b, g, n, etc.)) and Bluetooth wireless technologies. Thus, the communication may be a predefined structure as with a conventional network or simply an ad hoc communication between at least two devices.

An exemplary system may also include one or more server(s). The server(s) may also be hardware and/or software (e.g., threads, processes, computing devices). The servers may house threads to perform transformations by employing aspects of the present disclosure, for example. One possible communication between a client and a server may be in the form of a data packet adapted to be transmitted between two or more computer processes. The data packet may include a cookie and/or associated contextual information, for example. The system may include a communication framework (e.g., a global communication network such as the Internet) that may be employed to facilitate communications between the client(s) and the server(s).

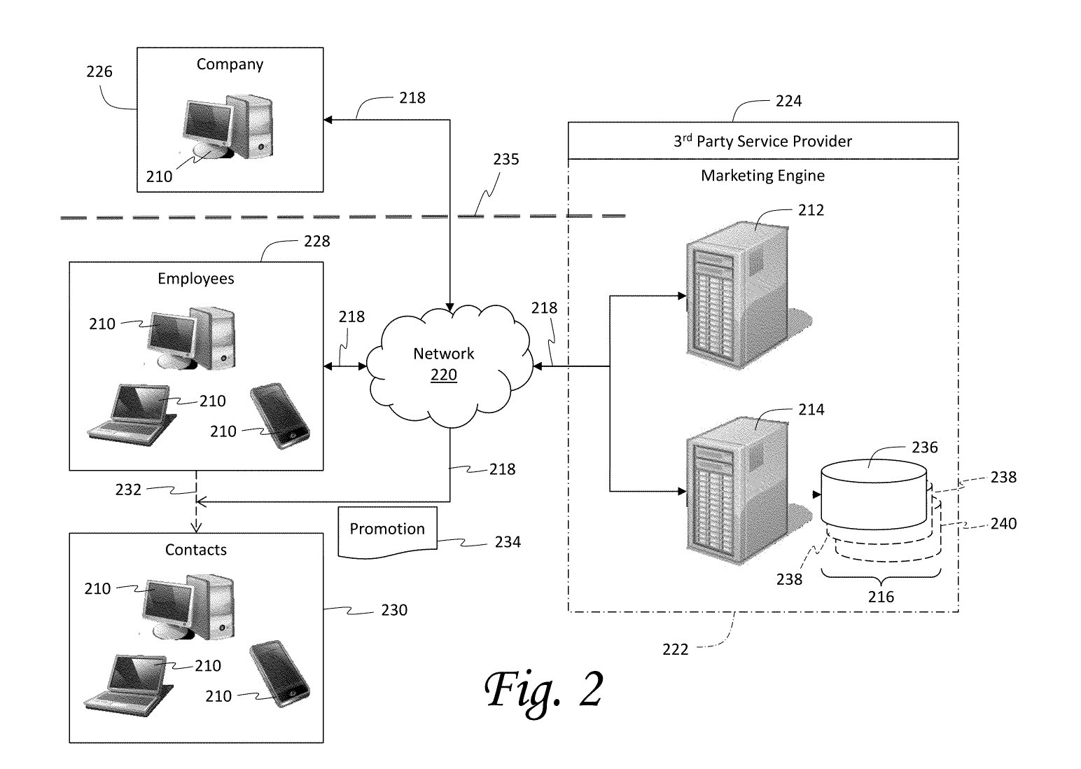

FIG. 2 illustrates a simplified, exemplary network diagram of a system 200 for using employees to market company promotions, in accordance with one or more embodiments of the present disclosure. The system 200 can be implemented in a networked client-server communications system in a manner described above. To this end, the system 200 may include one or more client devices 210, one or more application servers 212, and one or more database servers 214 connected to one or more databases 216. Each of these devices may communicate with each other via a connection to one or more communications channels 218 as described above. For instance, the communications channels 218 may be any suitable communications channels such as the Internet, cable, satellite, local area network, wide area networks, telephone networks, or the like. Any of the devices described herein may be directly connected to each other and/or connected over one or more networks 220. While the application server 212 and the database server 214 are illustrated as separate computing devices, an application server and a database server may be combined in a single server machine.

One application server 212 may provide one or more functions or services to a number of client devices 210. Accordingly, each application server 212 may be a high-end computing device, such as computer system 100, having a large storage capacity, one or more fast microprocessors, and one or more high-speed network connections. One function or service provided by the application server 212 may be a web application, and the components of the application server may support the construction of dynamic web pages. Additionally or alternatively, the application server 212 may support a local application on a client device 210, such as a mobile app, by communicating with the client device and performing various operations on a “back end.”

One database server 214 may provide database services to the application server 212, the number of client devices 210, or both. Information stored in the one or more databases 216 may be requested from the database server 214 through a “front end” running on a client device 210, such as a mobile app or web application. On the back end, the database server 214 may handle tasks such as data analysis and storage.

The one or more application servers 212, database servers 214, and the databases 216 may combine to form a marketing engine 222 that enables companies to market company promotions through an “employee media channel” in accordance with one or more embodiments of the present disclosure. As used herein, an employee media channel may refer to a private, assimilated group of connected people all related to a company through their connections with company employees in one or more social networks. Although the database 216 is shown as an internal database, one or more of the databases 216 may be a third-party database external to the marketing engine 222.

Relative to a typical application server 212 or database server 214, each client device 210 may typically include less storage capacity and processing power. For example, a client device 210 may be a personal computer, a portable computer, a personal digital assistant (PDA), mobile phone, a microprocessor-based entertainment appliance, a peer device or other common network node. The client device 210 may be configured to run a client program (e.g., a mobile app, a web browser, or the like) that can access the one or more functions or services provided by the marketing engine 222. Moreover, the client device 210 may access information or other content stored at the application server 212 or the database server 214.

On the server side of the system 200, the marketing engine 222 may be associated with a third party service provider 224. To this end, the third party service provider 224 may facilitate, transact or otherwise implement various aspects of the present disclosure using the marketing engine 222. On the client side, a company 226 (or other business entity) may transact with the third party service provider 224 through interactions with the marketing engine 222. As shown, such interactions with the marketing engine 222 may be conducted using one or more client devices 210. Likewise, a plurality of employees 228 of the company 226 may transact with the third party service provider 224 through interactions between a client device 210 and the marketing engine 222.

One or more embodiments of the present disclosure may empower companies 226 who wish to financially leverage the connected communities of their employees 228 to drive company revenues, brand awareness and product adoption. The marketing engine 222 described in the present disclosure may act as an engagement catalyst for these employees 228. The end result may provide an increase in sales coupled with decreases in the cost of advertising and promotional fees when compared to existing marketing and advertising options.

Foundationally, employees need their company to be successful to maintain the viability of the company and, as a result, their continued employment. Because employees have personal spheres of influence that can be utilized by their employer's advertising and marketing initiatives, the employees are in a position to directly impact the viability of their company. One-to-one marketing efforts by the employees are extremely powerful and impactful when compared to broader advertising messages. For instance, while a Vogue advertisement or a Superbowl campaign may be interesting, engaged involvement by employees within their spheres of influence may be more influential. By engaging employees in the promotion of the products and services offered by their company, the company can yield increased returns with minimal advertising costs.

To this end, the system 200 may further include a number of social contacts 230 connected to the plurality of employees 228 through one or more digital social networks (e.g., Facebook, Linkedln, Twitter, Google Plus, Instagram, Yelp, Meet Up etc.) or email clients (e.g., Outlook, Google, Yahoo, etc.), symbolized collectively by connector 232. As each individual employee 228 adds their digital and social connections, an aggregate of all contacts 230 is amassed creating the employee media channel.

As will be described in greater detail, an employee 228 may request or otherwise authorize the marketing engine 222 to deliver a company promotion 234 to one or more social contacts 230 through at least one digital social network 232 on behalf of the employee. As used herein, a promotion 234 may include a coupon, certificate, discount, offer, marketing message, press release, or any other item promoting brand awareness or company goodwill that may be electronically conveyed.

In return for this employee social marketing, the company 226 may reward those employees 228 for their involvement within their connected communities of social contacts 230 on the company's behalf through a series of rewards, each driven by a number of accumulated reward points (or similar reward currency). Employees 228 may earn these points through a cadence of “micro” marketing efforts driven by the marketing engine 222.

According to one or more embodiments of the present disclosure, employees 228 may participate in these micro-marketing activities without the company 226 knowing which employees are participating and the extent of that participation (i.e., who is doing what and how often). As such, an employee 228 may always have complete control over how their connected community is engaged knowing that the third party service provider 224 can act as a buffer between what the company 226 desires to be done and what the employee 228 is willing to do. Indeed, the marketing engine 222 may establish a firewall 235 for preventing the company 226 from receiving information indicating individual employee participation on the sharing of company promotions through the employee media channel.

An exemplary reward model includes a points-based program where employees 228 can earn “points” in an account each time they share a promotion through their social networks. Although a points-based reward program is described, other forms of reward currency may also be employed to encourage employee participation. The marketing engine 222 may track and manage employee reward points. In this manner, the marketing engine 222 offers an administrative platform that may, for example: 1) enable employees 228 to earn reward points for acting as surrogates to the marketing efforts of their company 226; 2) enable the employees 228 to be rewarded by their company 226 without the company knowing who has earned how much; 3) enable companies 226 to create, edit and delete rewards; and 4) enable employees 228 to “shop” for and purchase rewards using their reward points.

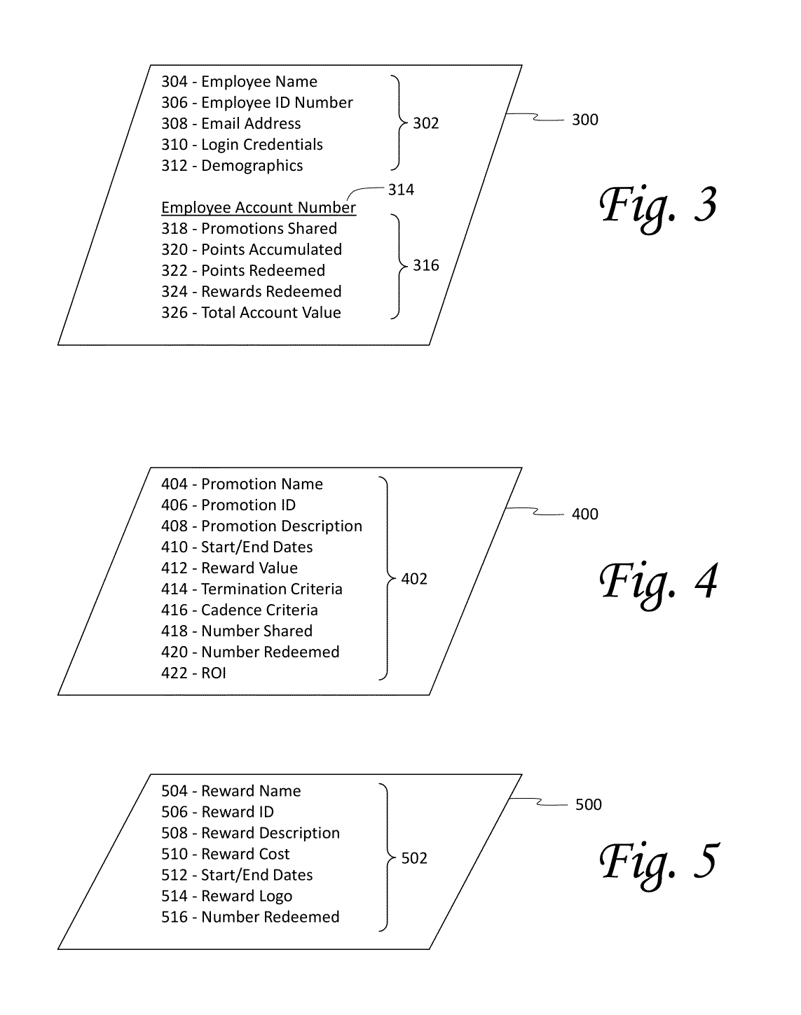

The one or more databases 216 may include at least an employee database 236 and a promotion database 238. With reference to FIG. 3, the employee database 236 may contain a database entry 300 associated at least with each employee 228 registered to participate in the sharing of company promotions. Each employee database entry 300 in the employee database 236 may include employee identification information 302, such as an employee name 304, an employee ID number 306, email address 308, login credentials 310, demographics 312, or the like. Each employee database entry 300 may be further associated with an employee account 314 for tracking the employee's promotion sharing activities. To this end, each employee database entry 300 may also include employee activity information 316. The employee activity information 316 may include data indicating the promotions in which the employee participated 318 (e.g., by sharing with at least one social contact), the reward points or other value accumulated as a result of the employee's participation 320, the amount of reward points expended in redeeming rewards 322, the rewards or other prizes redeemed 324, or the like. Further, each employee account may have a corresponding account value 326. The total account value 326 for each employee 228 may also be tracked in the employee database 236 and may be based on the reward points accumulated by each employee. The company 226 may be firewalled from the employee activity information 316, preventing the company 226 from receiving information indicating individual employee participation in the sharing of promotions.

With reference to FIG. 4, the promotion database 238 may contain data associated with a number of company promotions 234, including past, present and future promotions. Similar to the employee database 236, the promotion database 238 may include at least one database entry 400 associated with each promotion 234 created by the company 226 for their employees 228 to share using the marketing engine 222. Each promotion database entry 400 may include promotion information 402 such as a promotion name 404, a promotion ID number 406, a promotion description 408, promotion start/end dates 410, a reward value 412, termination criteria 414 (e.g., time, share limits, redemption limits, etc.), cadence criteria 416, a number of times the promotion was shared 418, a number of times the promotion was redeemed by a promotion recipient 420, a return on investment (ROI) for the particular promotion 422, and the like. By allowing companies to specify cadence criteria, the marketing engine 222 may cadence promotional campaigns so that the entire company does not participate at the same time. The cadence criteria may also specify a limit on the frequency with which an employee 228 can share a particular promotion 234. Additionally or alternatively, the cadence criteria may also specify a number of times and/or a frequency for sending a suggestion to an employee 228 to perform a certain task associated with the promotion 234.

Moreover, the promotion database 238 may include additional statistical data associated with the company promotions for use in analyzing marketing engine performance. For instance, the promotion database 238 may include data indicating the ROI generated on a promotional basis in total, the ROI generated by connection channel (i.e., digital social network) in total, or the like. Additionally, the promotion database 238 may include data indicating which promotions were most and least successful, which connection channels were most and least successful, amongst other data that may be used to generate reports for the company 226 or the third party service provider 224 to analyze.

The databases 216 may further include a reward database 240 in addition to the employee database 236 and the promotion database 238. With reference to FIG. 5, the reward database 240 may contain data associated with a number of rewards, including past, present and future rewards, that may be redeemed by an employee 228 using reward points or other reward currency accumulated through the sharing of company promotions 234 with friends and family. The reward database 240 may also contain data associated with various prizes or awards that may be earned through participation in the above-described micro-marketing activities. As an example, the reward database 240 may include a database entry 500 for each reward offered by the company 226 or third party service provider 224 as part of the aforementioned employee reward scheme. Each reward database entry 500 may include reward information 502 such as a reward name 504, a reward ID number 506, a reward description 508, a reward cost (e.g., point value) 510, a start/end date for reward availability 512, a reward logo 514, reward redemption totals 516, and the like.

The marketing engine 222 may provide an advertising platform having several components. While the overarching platform audience is directed to the social contacts 230 of employees 228, the system 200 may include at a number of audience channels providing direct access to the marketing engine 222. Two audience channels may be associated with the company 226. These company channels may provide, for example, administrative/human resources access and marketing access to the marketing engine 222. Another audience channel may be provided for the employees 228, giving them access to certain features and functions of the marketing engine 222.

While the server-side components of the system 200 may be referred to collectively as the marketing engine 222 for reference purposes, the marketing engine may be embodied in one or more modules associated with a server-side component, such as module 108 in the application server 212. To this end, FIG. 6 depicts a simplified, exemplary block diagram of a marketing engine module 600 for providing at least a portion of the marketing engine functionality.

The marketing engine module 600 may include a plurality of sub-modules including, for example, a company module 610, an employee module 612, and a targeting module 613. The company module 610 may provide designated personnel representing the company 226 a portal to various features of the marketing engine. For instance, the company module 610 may include an administrative component 614 providing the aforementioned administrative/human resources access and a marketing component 616 providing the marketing access. In particular, the administrative component 614 may provide a graphical user interface for receiving the employee identification information 302 from a program administrator granted access to the marketing engine 222 by the company 226. The program administrator may interact with the marketing engine 222 to perform a number of administrative activities. At a high level, these activities may include inputting the employee identification information 302 for all employees entered into the promotion sharing program. The employee information may be provided to the marketing engine 222 manually or via a spreadsheet-type file upload. The program administrator may also add new employees, delete employees and run various reports. The marketing engine 222 may build out the employee database 236 using the employee identification information 302 entered by the company's program administrator.

The administrative component 614 may also provide the program administrator with functionality to manage administrative-driven notification templates. For example, the program administrator may select, modify or draft notification templates for items such as a welcome message, a termination message, general informational message, legal policies and associated updates, or the like. The marketing engine 222 may distribute a communication to one or more employees 228 using the notification templates on behalf of the company 226.

Moreover, the program administrator may add, edit and delete available rewards. In creating a reward, the program administrator may input at least a portion of the reward information 502, such as the reward name 504, the reward description 508, the reward cost (e.g., point value) 510 to an employee, the start/end date for reward availability 512, the reward logo 514, or the like. As set forth above, the reward information may be stored in the reward database 240. The program administrator may also edit the same reward information for presently existing rewards.

The marketing component 616 may provide a graphical user interface for receiving certain promotion information 302 from a marketing administrator granted access to the marketing engine 222 by the company 226. The marketing administrator may interact with the marketing engine 222 to perform a number of promotion creation and management activities. It should be noted that the program administrator and the marketing administrator may be the same person. Moreover, for a given company, there may be multiple program and marketing administrators.

At a high level, the marketing administrator may access the marketing engine 222 to enter certain promotion information 402 for available company promotions 234. For example, the marketing component 616 may provide an interface for the marketing administrator to input the promotion name 404, the promotion description or creative 408, the promotion start/end dates 410, the reward value 412 credited to an employee 228 for sharing the promotion, the termination criteria 414 (e.g., time, share limits, redemption limits, etc.), the cadence criteria 416, or the like. The marketing administrator may also input message text to include with the promotion, as well as links to third party elements (e.g., coupons, prize engines, etc.). As set forth above, the promotion information 402 entered by the marketing administrator may be stored in the promotion database 238. The marketing engine 222 may generate the promotion 234 from the promotion information 402. The marketing administrator may also access the marketing component 616 to modify, archive, or delete promotions.

The program administrator and/or marketing administrator may request or otherwise view various reports and statistical data generated by the marketing engine 222 for analysis purposes. However, the content that may be reported back to the company 226 by the marketing engine 222 may not include information indicating individual employee participation in the propagation of promotions through the employee media channel (e.g., the employees' socially connected networks). Rather, the marketing engine 222 may provide the company 226 with information and data relating to employee participation in the aggregate. For instance, the marketing engine 222 may report promotion sharing totals to the company 226 in aggregate for the plurality of employees 228. Such information may include, for example: 1) how many employees 228 are participating in a particular promotion or overall; 2) how many reward points per employee has been generated overall or by a particular promotion; 3) how many “tasks” per month have been executed per employee on average; 4) how many social contacts 230 in total are in the connected audience of the company 226; 5) how many total social contacts 230 by channel (e.g., digital social network 232) are in the connected audience of the company; 6) total recipient redemptions overall or for a particular promotion; 7) total recipient redemptions by channel overall or for a particular promotion, etc.

With these and other reports, the company 226 may be provided a list active campaigns and the number of employees 228 who have participated in each. The list may include the number of distributions by promotion, the percentage of total population engaged by employees. The company 226 may also be provided with historical reports on promotion campaigns with the ROI of each, which may be further broken down by the digital social network employed. Again, such statistical information may include the number of distributions, the number of redemptions, and the number of long-tail impressions, amongst other items.

The employee module 612 may likewise provide the employees 228 of the company 226 a portal to various features of the marketing engine 222. For instance, the employee module 612 may include a promotion sharing component 618 and a reward redemption component 620 providing the aforementioned employee access. The promotion sharing component 618 may provide an interface for receiving authorization from employees 228 to share promotions 234 with their social contacts 230 through their digital social networks 232.

According to one or more embodiments of the present disclosure, the marketing engine 222 may send each employee 228 entered into the system an email invitation with default login credentials to gain access to the marketing engine 222 via a web-based application, mobile app, or the like. The invitation may include instructions for registering with the marketing engine 222 to gain access, including instructions for changing their password once registered. Once employees 228 log in, they may be able to view the currently available promotions 234 that they are able to propagate to their social contacts 230.

The employees 228 may be able to select which digital social networks 232 they would like to deliver promotions through. To this end, the marketing engine 222 may employ various application programming interfaces (APIs) available through each digital social network 232. Once the employee authorizes access to a social network 232, the marketing engine 222 may utilize the appropriate API and corresponding token to tap into and deliver promotions 234, on the employee's behalf, through selected networks in which the employee participates.

According to one or more embodiments of the present disclosure, the marketing engine 222 may allow piecemeal involvement of the employees 228 and their socially-connected contacts 230 in larger promotional initiatives. By allowing an employee 228 to undertake many small marketing tasks, regularly and/or frequently, the platform may make employee involvement both easy and exciting. Overlaying these employee actions with a rewards engine, described in greater detail below, may further motivate the employees to participate.

Using the employee interface, employees 228 can select the promotions 234 they want to propagate to their social connections, along with the distribution channel (i.e., social network 232) they would like the marketing engine 222 to use. Once an employee 228 makes those selections, the marketing engine 222 may send out the selected promotions through the channel API on its back end.

In an automatic mode, the marketing engine 222 may send email notifications to employees asking them to do very specific tasks, at their option. The email notification may include a link to access the employee's account through a web-based application to perform the suggested task. As one example, the marketing engine 222 may send a notification to a certain number of employees 228 requesting each employee to suggest a certain number of social contacts 230 to share a specific promotion 234. The employee 228 may be able to see what is being sent to each of their connections and the channel being used to communicate the promotion 234. For instance, the employee 228 may be able to see the specific Twitter posting, Facebook message or status update, etc. As another example, the marketing engine 222 may send a notification to an employee 228 suggesting specific contacts in the employee's social network 232 with which to share a particular promotion 234. In each instance, the employee 228 may be able to deselect a suggested contact or a channel and the promotion 234 would be sent only to those contacts that remain selected. The employee 228 may also be able to add a social contact 230 that was not suggested in the notification.

The marketing engine 222 may continuously and proactively solicit involvement through an email routine with similar task-specific suggestions the employee 228 can easily undertake. In addition to email notifications, the marketing engine 222 may send other types of electronic notifications with task-specific suggestions to an employee 228. For instance, the marketing engine 222 may send the employee 228 a text message, an instant message, or the like. According to one or more embodiments, the marketing engine 222 may push a notification directly to an employee's mobile device via a mobile-based application. In this context, the employee 228 may simply respond to the push notification with a simple “yes” or “no” using a decision button or similar interface element. As one example, the mobile app may push a message to the employee 228 asking whether the employee would like to send a specific promotion 234 to one or more particular contacts, eliciting a simple binary YES/NO response.

Thus, the marketing engine 222 may provide companies 226 the ability to set up a promotion campaign one time yet having a cadence overlay that filters back to the employees 228 an ongoing series of micro-promotions targeted to a subset of their social connections. Once a promotion 234 is delivered to a contact 230, the recipient would be provided instructions for redeeming the promotion, if desired. The promotion redemption process by a recipient may not involve the employee.

The reward redemption component 620 may provide an interface for employees 228 to redeem rewards for sharing promotions 234 with their social contacts 230. To this end, employees 228 may check their current point balance 320 or total account value 326, view a list of available reward items and corresponding reward costs, and request to redeem a reward item for the reward cost. The reward redemption component 620 may process the redemption request and facilitate the delivery of the selected reward item to the requesting employee. The reward redemption component 620 may further deduct the reward cost from the employee's current point balance.

In addition to the forgoing, the employee module 612 may provide report functionality to employees 228. For instance, the employee module 612 may run reports for employees indicating, for example, the promotions they have participated in (i.e., shared), which promotions were redeemed, how many of each promotion was redeemed, which contacts redeemed which promotions, as well as the employees' own reward points and reward redemption history.

One aspect of the advertising platform described herein is its ability to seamlessly deliver promotions 234 through the social networks 232 to employees' social contacts 230 in those networks while preventing the company 226 from knowing exactly which employee 228 is doing what with any particular promotion. The marketing engine 222 provides a portal for propagating unique marketing messages to the friends and family of the employees 228 without the company 226 ever knowing which employee is active.

The present disclosure discloses a unique business model where employee access is an agreement with the employee 228. The employees 228 may expect the company 226 to deliver promotions 234 that they will get rewarded with if they take action or otherwise participate in promotion sharing activities. Therefore, one key to the employee access may be the secure belief that what the employee 228 does will be unavailable, except in the aggregate for all employees, to the company 226.

As set forth above, each enrolled employee 228 may have an account 314 where his or her rewards are tracked. As part of the promotion set-up by the company 226, a reward value may be assigned to each activity the employee undertakes. According to one or more embodiments, the reward value may be measured in points. However, other forms of reward currency may be used as well. When employees 228 are notified of a promotion 234 they can be involved in, the reward value they can earn may be displayed. As an employee either expands on the program, or limits his or her involvement, the reward value may reflect these changes. As an example, 10 points may be awarded for each promotion 234 sent via a private message to a contact 230 in a social network 232, while 25 points may be awarded for publicly posting the promotion for all contacts in the employee's social network to view. When a promotion 234 is shared by an employee 228, the reward value earned may be placed into the employee's account 314 for used in redeeming rewards or other prizes.

According to one or more embodiments, a reward value may also be tied to redemption of the shared promotion with a promotion recipient. In this manner, when a promotion 234 is sent to a social contact 230 of the employee 228, it may include a special coupon, reward code, cookie, or similar tracking device. Although the promotion 234 may be redeemed by the recipient through the company 226, only the marketing engine 222 may know how this distinguishing tracking element traces back to an individual employee 228 so that the reward value may be credited to the employee's account 314.

In certain embodiments, the company 226 may offer a particular prize making it necessary to publicize the award. To remain anonymous, employees 228 can opt out of this public notification if they so choose. The marketing engine 222 may execute according to contest rules and the winner may be announced to the company 226 for the delivery of the award. However, any details about the size of the pool of employee contestants may be kept from the company 226. As an example, a company 226 may want to reward a flat screen TV or vacation time as an inducement for employee participation. In this case, the contest rules may be such that each time an employee 228 shares a promotion 234 with a social connection, the employee may get a singular entry. At the conclusion of an award period, the marketing engine 222 may select a winner and provide the employee's name back to the company 226 so the prize may be delivered.

Control over information indicating the amount rewarded to each employee 228 and the reward redemptions made by the employees may be maintained by the third party service provider 224 via the marketing engine 222. By maintaining this control at the marketing engine 222, the company 226 is out of the process and, as a result, cannot measure the participation of employees 228 based on these rewards.

Another component of the marketing engine 222 of the present disclosure may provide the ability for a company 226 to limit the number of social contacts 230 to which each employee 228 can send a particular promotion 234. This governor may serve the purpose of allowing a company 226 to limit its exposure on each campaign—both from a recipient redemption perspective as well as a cost/point perspective. In addition, by limiting the number of promotions 234, a company 226 can perform A/B testing of a promotion to identify which is more successful in attracting redemptions.

As yet another component of the marketing module 600 in marketing engine 222, the targeting module 613 may actively target the social contacts 230 of employees 228 with certain promotions 234, as described in greater detail below. To this end, the targeting module 613 may include a targeting component 622 with access to contact data accumulated in the building of an employee media channel 624. The targeting component 622, in conjunction with the employee media channel 624, may perform a cross-employee analysis of contacts 230 to maximize sharing opportunities while limiting the amount of times a contact 230 receives a promotion 234 from any individual employee 228.

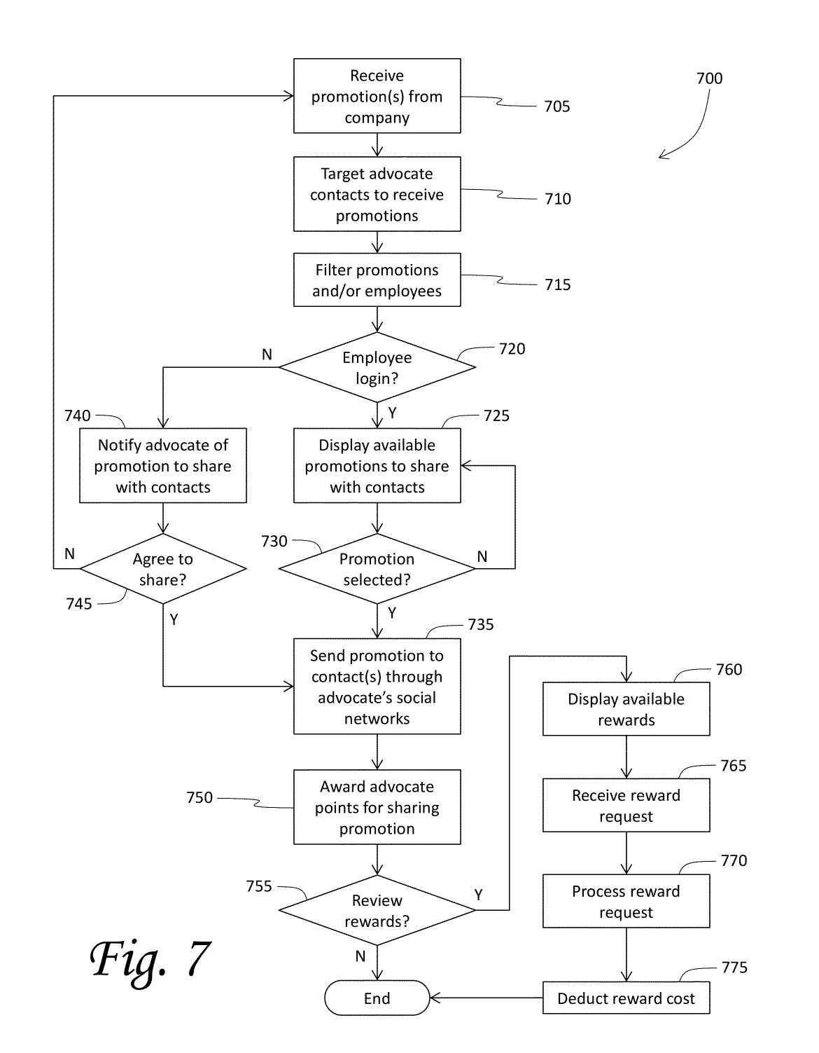

With reference now to FIG. 7, a simplified, exemplary flow diagram of a method 700 for marketing company promotions through an employee media channel is illustrated. At step 705, the marketing engine 222 may receive, from a company 226, input indicative of a promotion 234 and a reward value associated with sharing the promotion. The input may be stored in the promotion database 238 as promotion information 402. As referenced above, the marketing engine 222 may target the social contacts 230 of employees 228 to receive the promotion 234, as provided at step 710. When an employee registers with the marketing engine 222 and selects the digital social networks 232 to synchronize with the marketing engine, the targeting module 613 may retrieve data for each social contact 230 in the employee's social network for use in building the employee media channel 624. Further, the targeting module 613 may generate profiles for the social contacts 230 in each employee's socially-connected community for use in targeting social contacts with specific promotions. The profiles may be based on data received from third-party data sources partnered with the digital social networks 232 when synced with the marketing engine 222. Profiles for the social contacts 230 may be further based on first-party data obtained through direct involvement with the social contacts 230 through the marketing engine 222. The targeting component 624 may employ various targeting algorithms in order to provide an employee 228 with a list of suggested social contacts 230 to share a particular promotion with.

At step 715, the marketing engine 222 may filter the plurality of promotions 234 contained in the promotion database 238 to obtain a set of filtered promotions. For example, the marketing engine 222 may filter out promotions based on the termination criteria 414 or cadence criteria 416. Additionally or alternatively, the marketing engine 222 may filter the plurality of employees 228 in the employee database 236 that are participating in the promotion-sharing campaigns. For instance, for a particular promotion 234, the marketing engine 222 may filter the plurality of employees 228 based on, for each employee, whether and when the promotion 234 was previously shared by the employee based on the cadence criteria 416. As another example, for a particular promotion 234, the marketing engine 222 may filter the plurality of employees 228 based on, for each employee, whether a share limit for the promotion 234 has been reached based on the termination criteria 414.

At step 720, the marketing engine 222 may determine whether an employee 228 is logged in to the system through the employee interface. If employee login credentials are detected, the method may proceed to step 725. At step 725, the marketing engine 222 may notify the employee 228 of available promotions to share. The notification may be provided by generating an electronic form (e.g., a web-form in a web-based application) including the available promotions for displaying on a display of the client device 210 used by the employee 228 to access the marketing engine 222. At step 730, the marketing engine 222 may determine whether it has received authorization from the employee 228 to share a promotion 234 with a social contact 230 in a digital social network 232 of the employee. Receiving employee authorization may include receiving input indicative of a selection of the promotion 234 by the employee 228 and selection of a digital social network 232 by the employee 228. The employee interface may include selection widgets or other interface elements for performing the selection. Moreover, receiving employee authorization may further include receiving input indicative of a selection of a social contact 230 in the selected digital social network 232 by the employee 228.

If no authorization is received (e.g., no promotions are selected), the method may return to step 725 and the available promotions may continue to be displayed so long as the employee 228 remains logged in. On the other hand, if the marketing engine 222 receives authorization to share a promotion 234, the method may proceed to step 735.

Returning to step 720, if no employee login credentials are received, then method may proceed to step 740. At step 740, the marketing engine 222 may notify an employee 228 of the company 226 of a promotion 234 by sending an electronic communication about the promotion 234 to the employee 228 along with a request for employee authorization to share the promotion 234 with at least one social contact 230. The electronic notification may include an email notification. Alternatively, the electronic notification may be a notification pushed to the employee's mobile device via an associated mobile app, as described above. At step 745, the marketing engine 222 may detect whether the employee 228 has agreed to share a promotion 234. If no authorization to share the promotion 234 is received at step 745, the method may loop back to step 705. If, on the other hand, the marketing engine 222 receives authorization from the employee 228 to share the promotion 234, the method may proceed to step 735.

At step 735, the marketing engine 222 may send the promotion 234 to a selected social contact 230 through the select digital social network 232 on the employee's behalf. The promotion 234 may be sent by the marketing engine 222 through the social network 232 using an API on its back end. Once the promotion is shared, the marketing engine 222 may credit the reward value associated with the promotion to the employee's account. The marketing engine 222 may not provide the company 226 with information that could be used by the company to gauge the participation level of individual employees in the distribution of promotions 234 through this employee media channel.

At step 755, the marketing engine 22 may detect whether it has received a requested from the employee 228 to review available rewards. If not, the process may end or loop back to the beginning. If so, the method may proceed to step 760. At step 760, the marketing engine 222 display the available rewards by generating an electronic form including a number of available reward items and a reward cost for each reward item. At step 765, the marketing engine 222 may receive a redemption request, from the employee 228, to redeem a reward item for the reward cost. At step 770, the marketing engine 222 may process the redemption request to facilitate delivery of the reward item to the employee 228. Finally, at step 775, the marketing engine 222 may deduct the reward cost form the total account value 326 of the employee's account 314.

It should be noted that the method of FIG. 7 as described herein is exemplary only, and that the functions or steps of the method could be undertaken other than in the order described and/or simultaneously as may be desired, permitted, and/or possible.

It should also be noted that one or more embodiments of the present disclosure can be implemented in software and/or in a combination of software and hardware, e.g., using application specific integrated circuits (ASIC), a general purpose computer or any other hardware equivalents. For example, computer-readable instructions pertaining to the method(s) discussed above can be used to configure a hardware processor to perform the steps, functions and/or operations of the above-disclosed methods. In one or more embodiments, the module or process 108, 600 for providing a marketing engine 222 can be implemented as computer-executable instructions (e.g., a software program comprising computer-executable instructions) and loaded into memory 104 and executed by processor 102 to implement the steps, functions and operations as discussed above. As such, the module 600 for providing a marketing engine 222 (including associated data structures) of the present disclosure may be stored on a non-transitory (e.g., tangible and physical) computer readable storage medium, such as RAM memory, magnetic or optical drive or diskette, and the like. In this regard, it should be noted that any one or more of the devices described in connection with the present disclosure may be embodied by the system 100.

While exemplary embodiments are described above, it is not intended that these embodiments describe all possible forms of the invention. Rather, the words used in the specification are words of description rather than limitation, and it is understood that various changes may be made without departing from the spirit and scope of the subject matter presented herein. Additionally, the features of various implementing embodiments may be combined to form further embodiments of the present disclosure.

What is claimed is:

1. A method for marketing company promotions through an employee media channel comprising:
receiving, from a company, input indicative of a promotion and a reward value associated with sharing the promotion;
notifying a plurality of employees of the company about the promotion and the reward value;
receiving authorization from at least one employee to share the promotion with at least one social contact in at least one digital social network of the employee;
sending the promotion to the social contact through the digital social network on behalf of the employee using an application programming interface;
crediting the reward value to an account for each employee that shared the promotion; and
preventing the company from receiving information indicating individual employee participation in the sharing of promotions.

2. The method of claim 1, further comprising:
generating a report that provides the company with promotion sharing totals in aggregate for the plurality of employees.

3. The method of claim 1, further comprising:
receiving a share limit for the promotion for each employee; and
notifying the plurality of employees about the promotion and the reward value based on the share limit.

4. The method of claim 1, wherein notifying the plurality of employees comprises:
receiving login credentials for an employee; and
generating an electronic form including at least the promotion for display on a client device accessed by the employee.

5. The method of claim 1, wherein notifying the plurality of employees comprises:
sending an electronic communication about the promotion to an employee, the electronic communication including soliciting employee authorization to share the promotion.

6. The method of claim 5, further comprising:
receiving input indicative of a frequency for sending electronic communications about the promotion to the employee.

7. The method of claim 5, wherein the electronic communication is an electronic mail message.

8. The method of claim 5, wherein the electronic communication suggests a subset of social contacts in the employee's digital social network to share the promotion with.

9. The method of claim 1, wherein each employee account has a total account value based at least in part on reward values accumulated by the employee for sharing promotions, the method further comprising:
providing an electronic form including a number of available reward items and a reward cost for each reward item;
receiving a redemption request, from the employee, to redeem a reward item for the reward cost;
processing the redemption request to facilitate delivery of the reward item to the employee; and
deducting the reward cost from the total account value of the employee's account.

10. The method of claim 9, wherein the company is not provided with information identifying individual employee redemption activity.

11. The method of claim 1, wherein receiving authorization from at least one employee comprises:
receiving input indicative of a selection of the promotion by the employee and a selection of a digital social network by the employee.

12. The method of claim 11, wherein receiving authorization from at least one employee further comprises:
receiving input indicative of a selection of the at least one social contact in the selected digital social network by the employee.

13. The method of claim 12, further comprising:
receiving input from the company limiting the number of social contacts that the employee can select to share the promotion.

14. A computer system for providing a marketing engine for propagating company promotions through an employee media channel, the computer system comprising:
a memory device for storing computer-readable instructions; and
a processor for executing the computer-readable instructions stored in the memory device, the computer-readable instructions, when executed by the processor, implement the following functions:
receiving, from a company, input indicative of a promotion and a reward value associated with sharing the promotion;
notifying a plurality of employees of the company about the promotion and the reward value;
receiving authorization from at least one employee to share the promotion with at least one social contact in at least one digital social network of the employee;
sending the promotion to the social contact through the digital social network on behalf of the employee; and
crediting the reward value to an account for each employee that shared the promotion without providing the company with information indicating individual employee participation in the sharing of promotions through the employee media channel.

15. The system of claim 14, further comprising:
a promotion database for storing data associated with a number of company promotions including the promotion and the reward value; and
an employee database including an entry associated with each employee and corresponding to each employee account, each entry including employee identification information, employee activity information and a total account value.

16. The system of claim 15, further comprising:
a company module having a marketing component and an administrative component, the marketing component providing an interface for receiving promotion information input by the company and storing the promotion information in the promotion database, the administrative component providing an interface for receiving the employee identification information input by the company and storing the employee identification information in the employee database; and
an employee module having a promotion sharing component and a reward redemption component, the promotion sharing component providing an interface for receiving authorization from employees to share promotions with their social contacts through their digital social networks and crediting employee accounts corresponding reward values for sharing promotions, the reward redemption component providing an interface for employees to redeem rewards for sharing promotions and deducting the reward cost from the total account value;
wherein the company does not have access to the employee activity information and the total account value for each employee.

17. The system of claim 15, wherein the total account value for each employee account is based at least in part on reward values accumulated by the employee for sharing promotions, the computer-readable instructions further implementing the following functions comprising:
providing an electronic form including a number of available reward items and a reward cost for each reward item;
receiving a redemption request, from the employee, to redeem a reward item for the reward cost;
processing the redemption request to facilitate delivery to the employee; and
deducting the reward cost from the total account value of the employee's account without providing the company with information indicating individual employee redemption activity.

18. The system of claim 14, wherein notifying the plurality of employees comprises:
receiving login credentials for an employee; and
generating an electronic form including at least the promotion for display on a client device accessed by the employee.

19. The system of claim 14, wherein notifying the plurality of employees comprises:
sending an electronic communication about the promotion to an employee, the electronic communication including a request for employee authorization to share the promotion.

20. A non-transitory computer-readable storage medium containing machine instructions that, when executed by a processor, implement the following steps:
receiving, from a company, input indicative of a promotion and a reward value associated with sharing the promotion;
notifying a plurality of employees of the company about the promotion and the reward value;
receiving authorization from at least one employee to share the promotion with at least one social contact in at least one digital social network of the employee;
sending the promotion to the social contact through the digital social network on behalf of the employee using an application programming interface; and
crediting the reward value to an account for each employee that shared the promotion without providing the company with information indicating individual employee participation in the sharing of promotions.
